(19) United States
(12) Patent Application Publication
(10) Pub. No.: US 2004/0243656 A1
(43) Pub. Date: Dec. 2, 2004

(54) Digital signal processor structure for performing length-scalable fast fourier transformation

(75) Inventors: Cheng-Han Sung, Hsinchu (TW); Chein-Wei Jen, Hsinchu (TW); Chih-Wei Liu, Hsinchu (TW); Hung-Chi Lai, Kaohsiung (TW); Gin-Kou Ma, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/751,912

(22) Filed: Jan. 7, 2004

(30) Foreign Application Priority Data
Jan. 30, 2003 (TW) 092102079

(51) Int. Cl. G06F 15/00; G06F 17/14

(52) U.S. Cl. 708/404

(57) ABSTRACT

A digital signal processor structure by performing length-scalable Fast Fourier Transformation (FFT) discloses a single processor element (single PE), and a simple and effective address generator are used to achieve length-scalable, high performance, and low power consumption in split-radix-2/4 FFT or IFFT module. In order to meet different communication standards, the digital signal processor structure has run-time configuration to perform for different length requirements. Moreover, its execution time can fit the standards of Fast Fourier Transformation (FFT) or Inverse Fast Fourier Transformation (IFFT).

### FIELD OF INVENTION

The present invention relates to a digital signal processor structure by performing length-scalable Fast Fourier Transformation (FFT). More particularly, a single processor element (single PE) and a simple and effective address generator are used to achieve length-scalable, high performance and low power consumption in split-radix-2/4 FFT or IFFT module.

### BACKGROUND OF INVENTION

Discrete Fourier Transformation (DFT) is one of the important functional modules in Orthogonal Frequency Division Multiplexing (OFDM) communication systems. However, in this case, large numbers of operations are performed and applied in hardware. Conventionally, the computation complexity is equal to length square. Therefore, how to effectively decrease the numbers of operations is always the target for the designers.

The traditional FFT algorithm derivation, such as fixed-radix or split-radix, makes DFT fast and effectively applies in hardware. For split-radix FFT, it has the least computation complexity in traditional FFT algorithms. However, the signal flow graph of split-radix FFT algorithm presents L-shape structure. This makes split-radix FFT digital signal processing structure is harder for implement rather than regular butterfly operation of fixed-radix FFT structure. As a result, fixed-radix FFT, which has larger computation complexity, is widely used rather than split-radix FFT. Its digital signal processor structure includes two types, which are the pipeline and single processor element structures. For the pipeline structure, it has higher throughput rate and the signal control is simple. Thus its processing speed is faster than the single processor element structure. However, the implement of the pipeline structure requires more rooms in hardware. In contrast, the single processor element is an area-efficient architecture and requires less memory rooms, but is more complicated in control signals. For example, it requires a memory address generator to generate addresses to fit the butterfly operation of the single processor element. By the motions of write-in and read-out for data control, the single processor element can perform completely FFT algorithm.

The designed FFT module requires to support length-scalable algorithm to satisfy with various communication system standards. For example, 802.11a-system requires 64-point FFT algorithm, and 802.16-system requires 64-4096 points FFT algorithm. As a result, the FFT module requires providing length-scalable function, which can use run-time configuration to perform required FFT or IFFT algorithm within standard latency-specified time. From hardware design point of view, the single processor element structure is more reliable than pipeline structure to design a re-configurable FFT digital signal processing structure.

The present invention relates to a digital signal processor structure which provides length-scalable function and execution time to satisfy with communication standards within latency-specified requirement for FFT module in the single processor element structure. This module adopts split-radix FFT algorithm. Thus it would have lower computation complexity. Besides, run-time configuration is also to be used here. Other advantages of this design in this invention are low power consumption, high performance and limited storage elements.

### SUMMARY OF THE INVENTION

The present invention relates to a digital signal processor structure by performing length-scalable Fast Fourier Transformation computation. More particularly, a single processor element (single PE) and a simple and effective address generator are used to achieve length-scalable, high performance and low power consumption in split-radix FFT module. The FFT processor architecture uses the concept of in-place computation. The processor element of FFT structure can read data from memory, and can process and rewrite them back to the same positions in memory. The FFT module requires providing length-scalable function and execution time to satisfy with different communication standards within latency-specified requirement for FFT module of the single processor element structure. The present invention uses multiple single-port memory banks to alternate a multi-ports memory. Moreover, it decreases the read and write actions in memory banks and also reduces the power consumption at the same time. In order to satisfy with different required twiddle factor complex multiplications in split-radix FFT algorithm, the present invention provides a dynamic prediction method and additionally uses a conventional look-up table to implement. The look-up table only needs to save approximately ⅛ of the twiddle factors here. Besides, in order to achieve present communication system requirement or higher transmission speed as future system required, the structure of present invention can easily increase the numbers of processor elements for example, using two processor elements, and which can wholly enhance efficiency in the same clock rate.

The forgoing and other objects, features and advantages of the present invention will be better understood from the following description taken in connection with the accompanying drawings, in which:

### BRIEF DESCRIPTION OF THE DRAWINGS

FIG. 1 is an explanatory view of a prior art showing a 6-bit data process.

FIG. 2 is a preferred embodiment of the present invention showing a 4-bit data memory allocation.

FIG. 3 is a preferred signal flow graph of the present invention showing the butterfly operation.

FIG. 4 is a preferred embodiment of the present invention showing a replicated radix-4 core processor element.

FIG. 5 is an explanatory view of a prior art showing a single processor element structure.

FIG. 6 is a preferred embodiment of the present invention showing the interleave rotated non-conflicting data format.

FIG. 7 is a preferred embodiment of the present invention showing the data rotator structure.

FIG. 8 is a preferred embodiment of the present invention showing the length-scalable FFT digital signal processing structure.

FIG. 9 is a preferred embodiment of the present invention showing the data arrangement of an accumulated structure.

FIG. 10 is a preferred embodiment of the present invention showing the address generator of an accumulated structure.

FIG. 11 is a preferred embodiment of the present invention showing the accumulated processor.

FIG. 12 is a preferred embodiment of the present invention showing the state of the digital signal processing structure.

FIG. 13 is a preferred embodiment of the present invention showing the condition of the state of a digital signal processing structure.

### DETAILED DESCRIPTION OF THE PREFERRED EMBODIMENTS

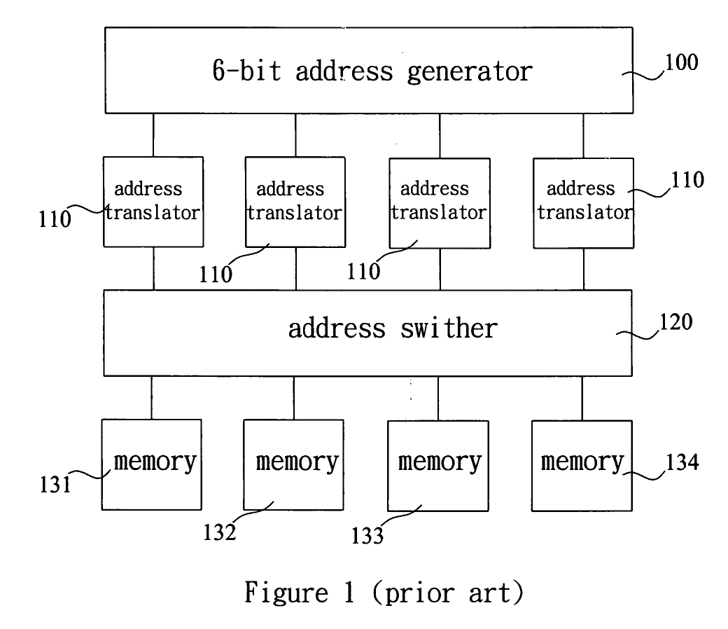

The present invention relates to a length-scalable FFT processor structure, which uses multi-memory banks method to perform as called interleave rotated data allocation (IRDA) method. It can enhance data access parallelism and make data sequentially be arranged into memory banks. For example, the rules of data arrangement in processing 64-point and 256-point FFT or higher-points FFT are the same. The address generator of these data has expandability and can be designed easily by using a counter. By using a single processor element and the concept of in-place computation, the processor element can read and process data from memory and re-write them back to the same positions in the memory. Based on expandability and fast dynamic adjustment, the present invention can decrease hardware loading and meet different length FFT requirements. FIG. 1 is a prior art presenting a 6-bit data process in the single processor element structure. A 64-point FFT processor is an example in this figure, which requires reading 4 data at the same time and writing 4 data back after finishing the butterfly operation. As a result, it needs 4 sets of address translators 110 to translate 4 single-port addresses to new positions and to new memory banks, which are 131,132, 133 and 134. Apart from translating positions, it also requires address switcher to correctly switch addresses to the corresponding memory banks. Therefore, it not only translates addresses but also locates them into corresponding memories for correctly reading data.

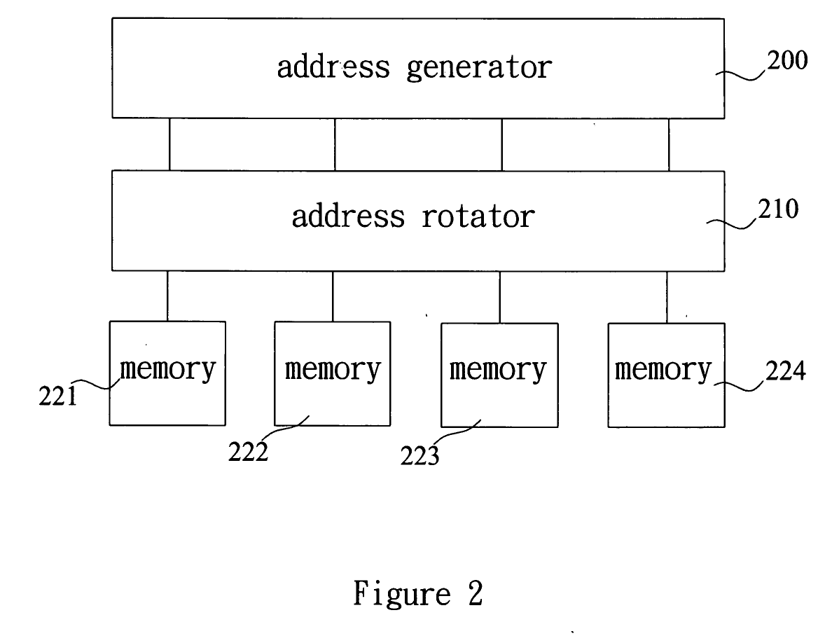

Please referring to FIG. 2, it is a preferred embodiment showing a 4-bit data allocation. This embodiment is a 64-point FFT processor with multiple memory banks, but it should not be limited to 4 memory banks for practice as shown in the figure. A 4-bit address generator 200 is an example herein, which can generate a set of 4 memory addresses. Using the 4-bit address generator 200 which can generate 4 addresses each time as an example herein, a set of memory addresses is processed. This set of memory address uses simple rotated method to produce three other corresponding sets of memory addresses. The step of the process is performed by the address rotator 210 as shown in the figure. This means that a set of 4 memory addresses can generate sequentially 4*4 memory addresses from address rotator 210. Therefore, it only requires 4-bit address generator 200 of interleave rotated data allocation method by processing 64-point FFT algorithm. In contrast to 6-bit data processing structure of the prior art, the requirement for address generator in the present invention decreases to 4-bit. More additionally, well arranging on addresses by using address rotator can decrease hardware complexity. While processing 256-point FFT algorithm, the same data arrangement only needs a 6-bit address generator. Other processing length can follow this rule to perform as well.

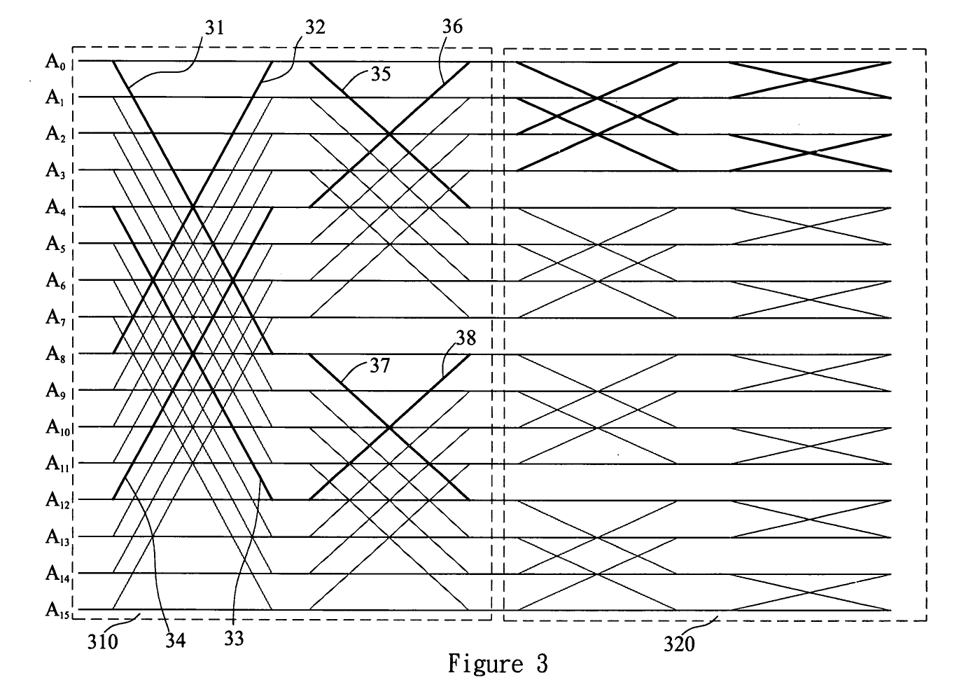

FIG. 3 is a preferred signal flow graph of the present invention showing the butterfly operation. The present invention utilizes the split-radix-2/4 FFT algorithm to design the processor element, which can have less complex multiplication arithmetic and can decrease access times in memory banks for achieving the purpose of low power consumption in this invention. As shown in the Figure, it presents the signal flow graph of a 16-point split-radix-2/4 FFT algorithm. The first data line A0 and the 9^{th} data line A8 have two cross-hatched lines to link. The first cross-hatched line 31 and the second cross-hatched line 32 in the figure are called the butterfly operation. Besides, the 5^{th} data line A4 and the 13^{th} data line A12 also have two cross-hatched lines to link. The 3^{rd} cross-hatched line 33 and the 4^{th} cross-hatched line 34 can use the same method to perform the similar operation. The butterfly operation in the signal flow graph can be performed by using corresponding complex multiplication operations. The start and the end in each butterfly operation corresponds to access actions in memory. Therefore, well choosing operation data can decrease unnecessary memory access actions.

As shown in FIG. 3, the 16-point split-radix-2/4 FFT signal flow graph is divided into 2-stage (log₄ 16=2) operations, which are 310 and 320 respectively. In each stage, it processes 4 data at the same time which is called a cycle. Thus, it requires 4 cycles at each stage. Each cycle has two operations. The first operation result does not restore back to the memory. However, after well translating process, it feedbacks to the same hardware to perform the second operation, and the result of the second operation can restore back to the original memory positions. Consequently, the next stage will perform the similar process after completing data process of all the next cycles in the present stage. The following presents the above action in details. As shown in the Figure, it presents a 16-point split-radix-2/4 FFT signal flow graph. It is divided into 2-stage (log₄ 16=2) operations, which are 310 and 320 respectively. Each stage requires 4 cycles. In the first stage 310, the 4 data in the first cycle is the butterfly operation between the 1^{st} data line A0 and 9^{th} data line A8, and another butterfly operation is between 5^{th} data line A4 and the 13^{th} data line A12. These 4-data operation results do not need to store back to the memory, and it will consequently perform the second operation. The 1^{st} operation results will pass to the following two butterflies to perform the second operation, which means the butterfly operation between the 5^{th} cross-hatched line 35 and the 6^{th} cross-hatched line 36, and between 7^{th} cross-hatched line 37 and the 8^{th} cross-hatched line 38. After finishing the second operation, the results will restore back to the original memory positions. The second cycle will process operation of the next 4 data as shown in the figure. The butterfly operation between the 2^{nd} data line A1 and the 10^{th} data line A9 and the butterfly operation between the 6^{th} data line A5 and the 14^{th} data line A13 can be seen from the graph. It uses the same concept to perform the following stages, like the second stage 320 in this figure. The present invention uses a processor element to perform corresponding butterfly operation, and which can save half of memory access times for achieving the purpose of low power consumption.

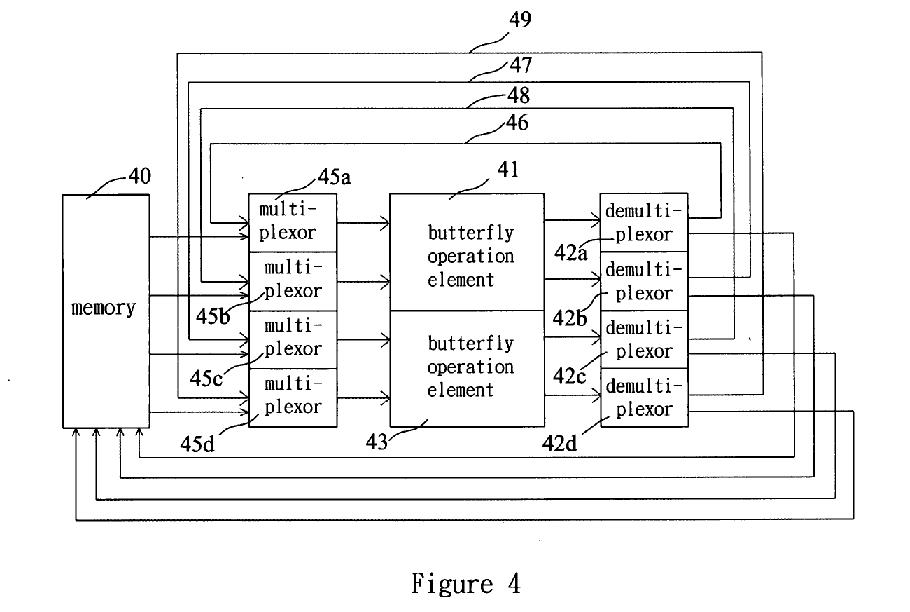

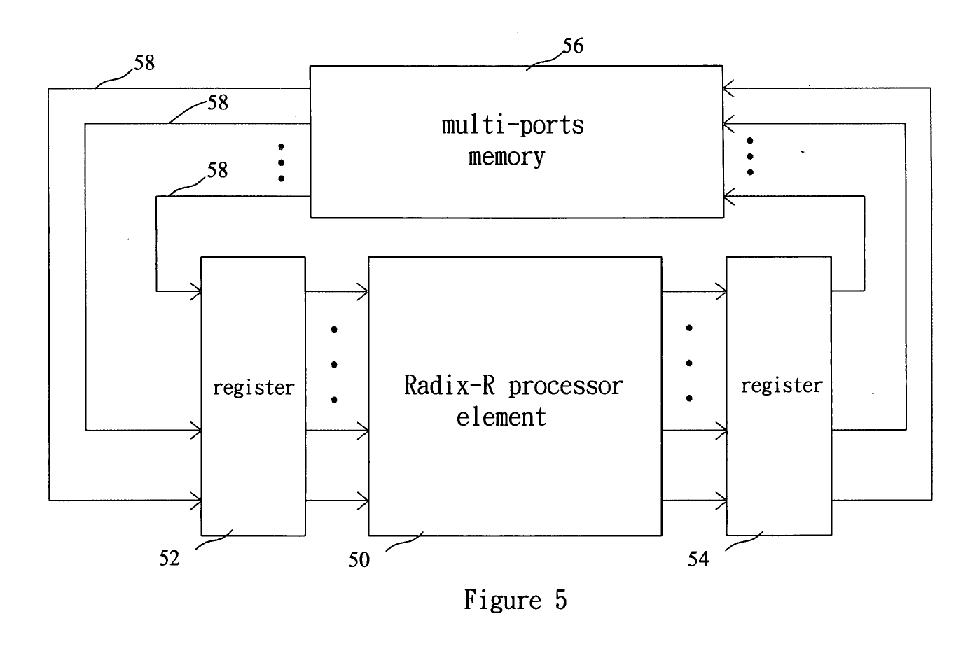

FIG. 5 is a prior art presenting a single processor element structure. A processor element of the radix-r core 50 is set here. The r numbers of data are read from a multi-port memory through the first register 52. After performing the butterfly operation through a radix-r core processor element, the processed data are re-write back to the original multi-port memory 56 by in place memory address through the second register 54. As a result, the said multi-port memory 56 requires satisfying the read and write actions for r numbers of data. If r is 4, then it requires a 4-port memory to read and write at the same time. The area, complexity, and power consumption of the memory increase when the required numbers of the memory ports increase. Another implementation method is to use r numbers of the single-port memory banks as shown in the FIG. 2 to alternate an r-port memory for achieving the advantages of area-efficient, low complexity and low power consumption. The FIG. 4, which is the preferred embodiment of the present invention, adopts the architecture of the single-port memory banks method.

Please referring to FIG. 4, it illustrates a replicated radix-4 core. The processor element of the replicated radix-4 core in the figure has four multiplexers and four demultiplexers, which can process 4-point FFT algorithm each time. The preferred embodiment of the present invention is designed to have feedback paths, for example, the 1^{st} feedback path 46, the 2^{nd} feedback path 47, and 3^{rd} feedback path 48 and the 4^{th} feedback path 49 which replicate hardware during the two operations in each cycle. It is divided into two parts in the figure; which the upper part is the 1^{st} butterfly operation element 41 and the lower part is the 2^{nd} butterfly operation element 43. It can correctly feedback the 1^{st} operation results to perform the second operation by using the same hardware example, the multiplexers 45a, 45b, 45c and 45d read 4 data from the memory 40. Further, the following first butterfly operation element 41 receives the data from the first multiplexer 45a and the second multiplexer 45b. Then, by using the results of the butterfly operation element 41, they feedback to the first multiplexer 45a and the third multiplexer 45c through the first demultiplexer 42a and the second demultiplexer 42b along the first feedback path 46 and the second feedback path 47. Besides, the second butterfly element 43 receives the data from the third multiplexer 45c and the fourth multiplexer 45d. Then, by using the results of the butterfly operation element 43, they feedback to the second multiplexer 45b and the fourth multiplexer 45d through the third demultiplexer 42c and the fourth demultiplexer 42d along the third feedback path 48 and the fourth feedback path 49. Then these 4-data are loaded into butterfly operation element 41 and 43 through multiplexer 45a, 45b, 45c and 45d to perform the second operation. According to the above description, the replicated radix-4 core module can process read and write actions for 4-data each time between two of the butterfly operations. It can feedback the results of the previous butterfly operation and use the same hardware to perform the second operation. The multiple demeltiplexers 42a, 42b, 42c and 42d are used to determine if the data operation results write back to the memory 40 or follow the feedback paths and go to multiple multiplexers 45a, 45b, 45c and 45d for the second operation. The first butterfly operation element 41 and the second butterfly operation element 43 additionally set complex multipliers for determining whether to perform complex multiplication operations.

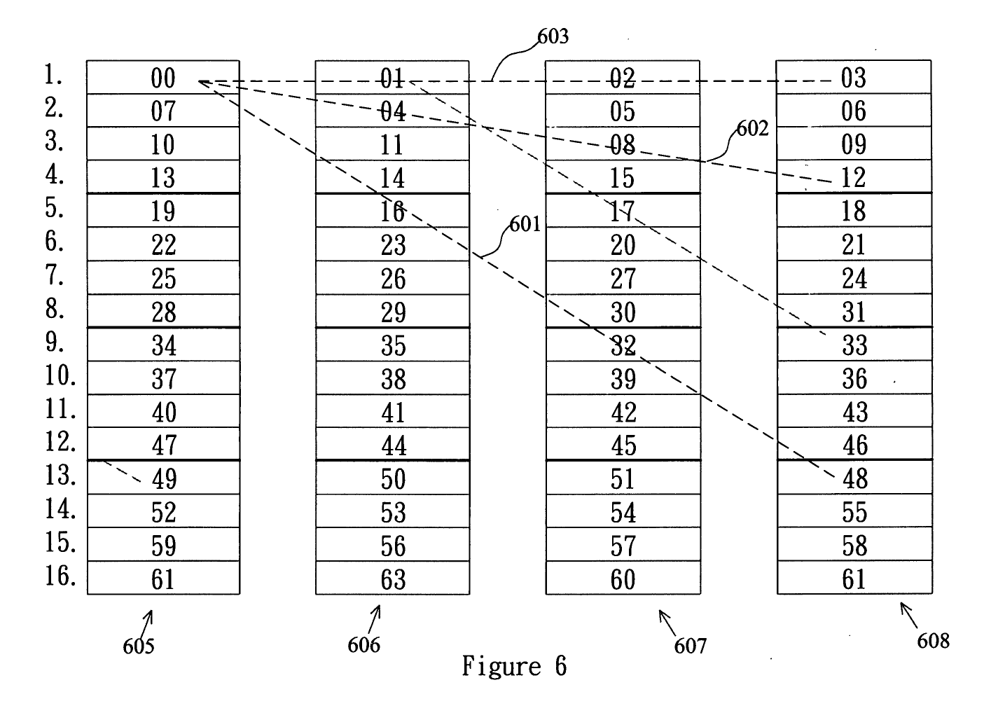

Using a conflict free memory addressing technique for single-port memory banks can make data in adequate arrangement, and then the required r numbers of data in any stage all can successfully be arranged in the memory banks of r single-port memory. Thus the data conflict will not occur when using the replicated radix-4 core to access memory banks. This kind of data arrangement can be called Interleave Rotated Data Allocation (IRDA) or a non-conflicting data format. While FFT module needs to be repeatedly used and non-conflicting data format are totally different during processing different length FFT algorithm, it will induce heavy load in the hardware complexity. Prior art needs a complicated addressing technique, which can prevent data conflict situation, to allocate data into memory. Please referring to FIG. 6, it is a preferred embodiment of the present invention showing interleave rotated non-conflicting data format.

The present invention refers to the IRDA method, which can overcome the problem that prior art has. As shown in the Figure, it is an example of a 64-point FFT in the memory banks of 4 single-port memory. It is divided into 3-stage (log₄ 64=3) operations. Each stage requires 16 cycles. In the first stage, the required 4 data in the first cycle are positioned in different numbers of memories, which are 00, 16, 32 and 48. The data 00 is positioned in the 1^{st} row of the 1^{st} memory 605. The data 16 is positioned in the 5^{th} row of the 2^{nd} memory 606. The data 32 is positioned in the 9^{th} row of the 3^{rd} memory 607. The data 48 is positioned in the 13^{th} row of the 4^{th} memory 608. The first line 601 as shown in the figure is the linkage of the 4 numbers. The second cycle is positioned in the following numbers of the memories, which are 01 the 1^{st} row of the 2^{nd} memory 606, 17 the 5^{th} row of the 3^{rd} memory 607, 33 the 9^{th} row of the 4^{th} memory 608, and 49 the 13^{th} row of the 1^{st} memory 605. The 4-data in the third cycle are positioned in 02, 18, 34, and 50. Other cycles can use this way to do analogy. This will form a circular symmetrical type. In the second stage, the required 4 data in the first cycle are positioned in different numbers of memories, which are 00 the 1^{st} row of the 1^{st} memory 605, 04 the 2^{nd} row of the 2^{nd} memory 606, 08 the 3^{rd} row of the 3^{rd} memory 607, and 12 the 4^{th} row of the 4^{th} memory 608. The second line 602 as shown in the figure is the linkage of the 4 numbers. The 4-data of the second cycle are positioned in the different numbers of memories, which are 01, 05, 09, and 13 as well as they form a circular symmetrical type. To process the last stage, the first cycle for the 4 data are positioned in 00, 01, 02 and 03. The third line 603 as shown in the figure is the linkage of the 4 numbers, and which also form non-conflicting data access method.

As shown in the FIG. 6, it is the data storage order of the memory. The first row is 00, 01, 02, and 03. The second row is 07, 04, 05, and 06. The third row is 10, 11, 08, and 09. As can be seen, the 1^{st} position 00 of the 1^{st} row is in the 1^{st} memory 605. The 1^{st} position 04 of the 2^{nd} row is positioned in the 2^{nd} memory 606. The method is taken by shifting the 1^{st} memory 605 to the 2^{nd} memory 606, and other positions are placed referring to this similar method. Besides, the four memory banks as shown in the Figure are shifted in order and others can refer to this method, too. For example, the 1^{st} position 08 of the 3^{rd} row is positioned in the 3^{rd} memory 607. However, there is another rule here below. While the data of the 4^{th} row shifting to the 5^{th} row in order, the shift should take two positions. The data from the 5^{th} row to 8^{th} row still keeps one-position shift. The two-position shift is applied in the 9^{th} row. Every quadruple-row would take two-position shift. The above order forms interleave rotated non-conflicting data format and is a preferred embodiment of the present invention as shown in the FIG. 6.

From above description, the data arrangement and the corresponding memory addresses form a circular symmetrical type. After the address generator generates the first set of memory addresses for the single processor element, the successive address sets can be generated from the first set by the circular shift rotator. As a result, if the core processor element r is 4 as shown in the Radix-r core of the FIG. 5, it only requires a 4-bit address generator when processing 64-point FFT algorithm as shown in the FIG. 2.

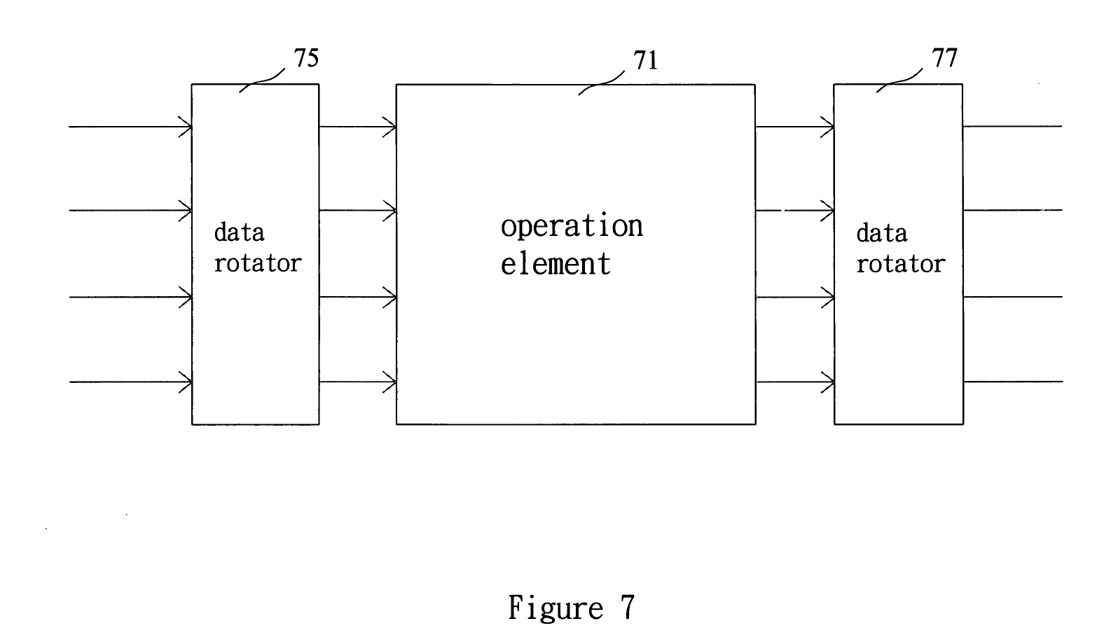

The data stored in the memory banks by a circular method is presented in above symmetrical rule. As a result, it requires well adjusting left and right rotations for the data when reading the data from the memory banks or writing the operation results to the memory banks. FIG. 7 is a preferred embodiment of the present invention showing the data rotator structure. These 4-data, which read from memory banks, circularly left rotate by using the data left rotator 75. Then, the processor element performs the butterfly operations. After that, the operation results circularly right rotate through the data right rotator 77. The rotated 4-data then write back to the memory banks according to the rotated addresses.

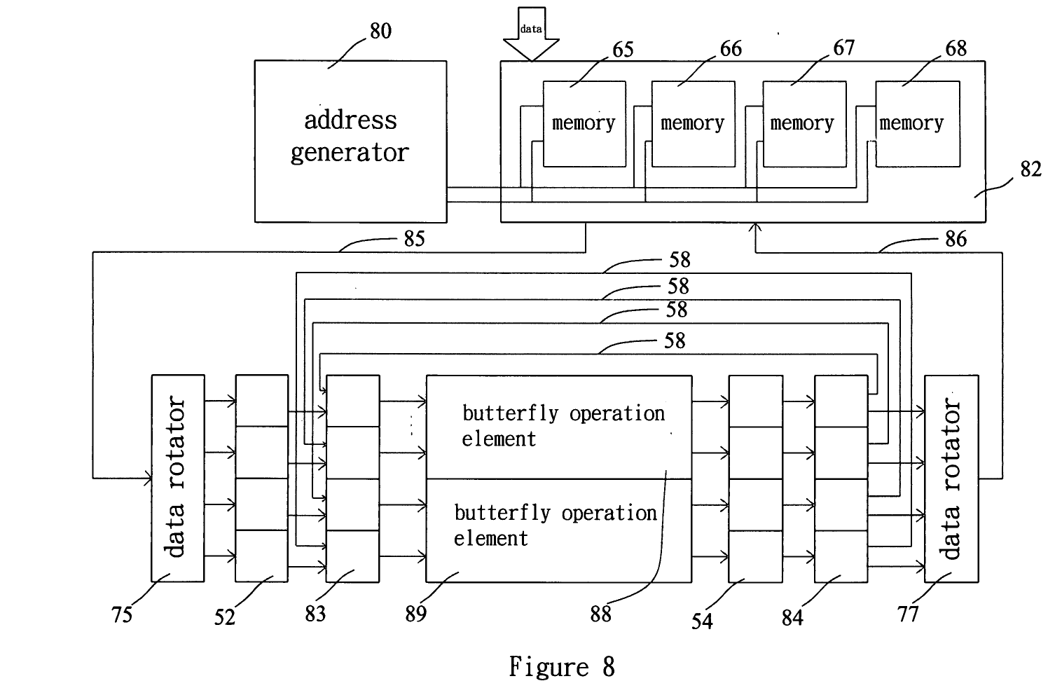

Please referring to the FIG. 8, it is a preferred embodiment of the present invention showing length-scalable FFT digital signal processing structure. The memory 82 includes the first memory 65, the second memory 66, the third memory 67, and the fourth memory 68 as shown in the FIG. 6. Also, it presents 4 blocks showing the register, the multiplexer, and the demultiplexer. The multiple input data write into the memory 82 by using the interleave rotated data allocation method. Then the multiple data from different memory banks but with circular symmetric property are put into the first register 52 through the first data rotator 75. It uses the first multiplexer 83 to allocate them to the first butterfly operation element 88 and the second butterfly operation element 89 for the first operation. The operation results are stored into the second register 54. Then it uses the first demultiplexer 84 to transfer the first operation results into the first multiplexer 83 along the feedback path 58. Further, the first butterfly operation element 88 and the second butterfly operation element 89 perform the second operation. This kind of repeated storage actions through the feedback path can decrease memory access times. After the processor element finishes the second operation of a cycle, the operation results write back to the same memory positions through the second register 54, the first demultiplexer 84 and the second data rotator 77. Then, it continues to process the next cycle operations. While completing all the cycles in the present stage, it performs the similar operation in the next following stages. By the above flow chart and structure, it can achieve the purposes of low hardware loading, low power consumption and less multiplication operation as described in the present invention.

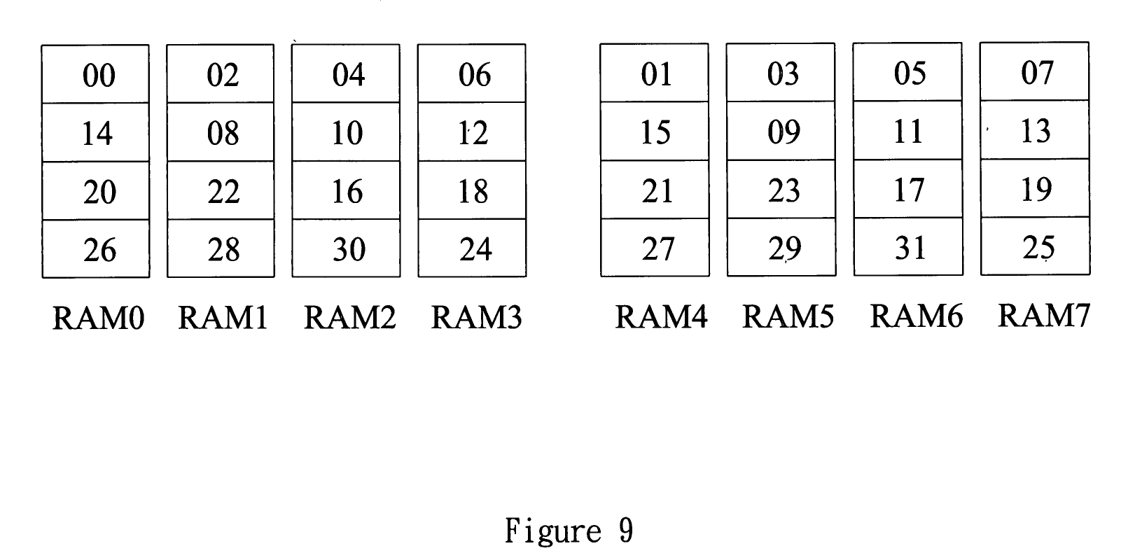

In order to meet the performance requirement of different OFDM communication systems, high speed FFT module is preferred. The proposed structure in the present invention can increase the numbers of the processor element for example, using two processor elements in the same clock speed for enhancing the whole module's efficiency with double times. As can be seen from the FIG. 9, it presents the data arrangement as an accumulated structure of the length-scalable FFT digital signal processing structure. For the 32-data arrangement in 8 single-port memories, it divides the required data into odd data parts and even data parts, and then arranges them to multiple memory storage elements, respectively. The even data parts are arranged in the first memory RAM0, the second memory RAM1, the third memory RAM2 and the fourth memory RAM3 by following the interleave rotated non-conflicting data format as shown in the FIG. 6. The odd data parts are arranged in the fifth memory RAM4, the sixth memory RAM5, the seventh memory RAM6 and the eighth memory RAM7 by following the data format as shown in the FIG. 6.

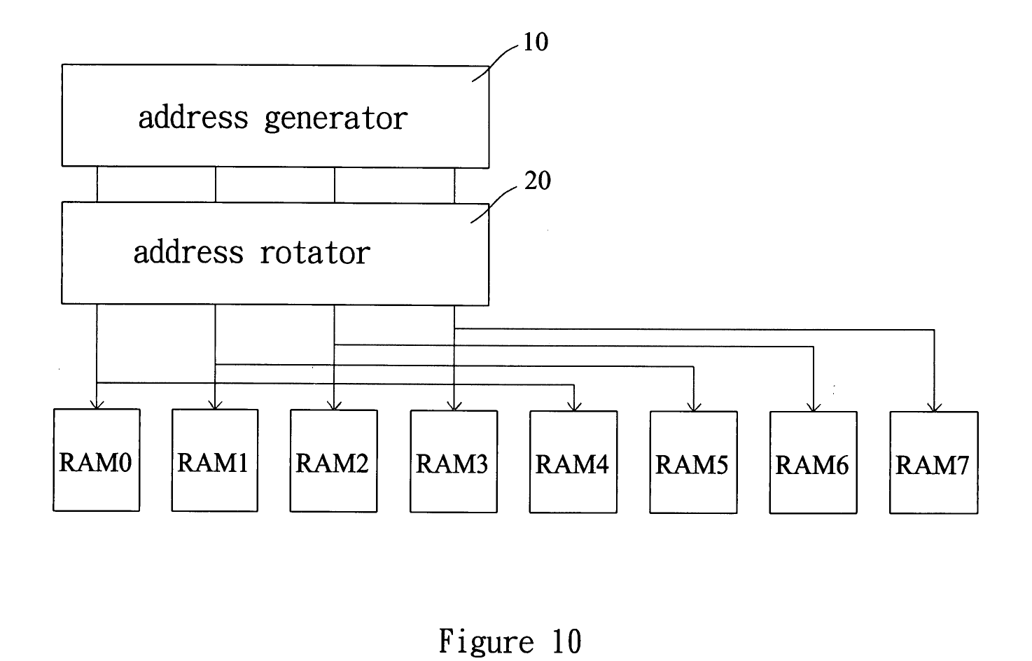

FIG. 10 is a preferred embodiment of the present invention showing the address generator of an accumulated structure as referring to the address generator in FIG. 9. The 4 addresses produced from the address generator 10 can generate the corresponding memory address sets by using the address rotator 20. The required memory address in the first memory RAM0 is coincident with that in the fifth memory RAM4. The required memory address in the second memory RAM1 is coincident with that in the sixth memory RAM5. The required memory address in the third memory RAM2 is coincident with that in the seventh memory RAM6. The required memory address in the fourth memory RAM3 is coincident with that in the eighth memory RAM7. By using the above arrangement method, it can implement the address generators of the multiple single-port memories without increasing the hardware cost.

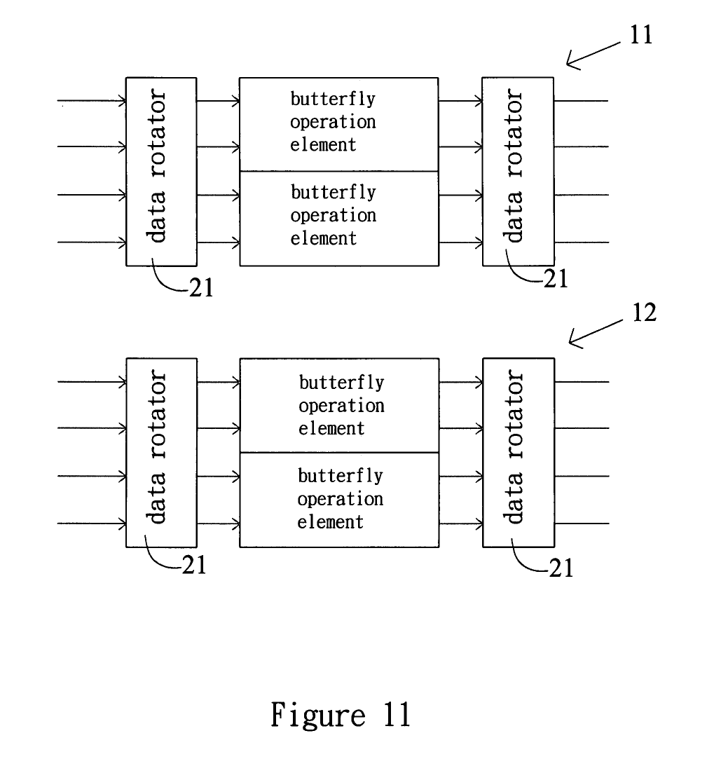

For the 8 single-port memories as shown in the FIG. 10, the processor element needs to process 8 data at the same time. Then it can use an accumulated processor structure as shown in the FIG. 11. FIG. 11 is a preferred embodiment of the present invention showing the accumulated processor. It contains the first processor element 11 and its surrounding multiple data rotators 21 and the second processor element 12 and its surrounding multiple data rotators 21.

Another design issue of FFT module is the complex multiplication operations of the twiddle factors. The present invention provides a dynamic prediction method for the twiddle factors and additionally takes the look-up table to implement. The look-up table only requires ⅛ of the twiddle factors.

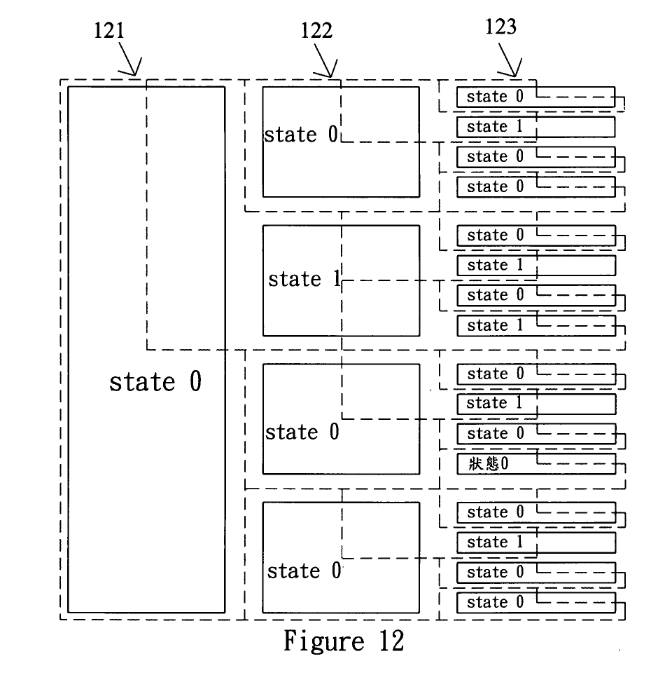

Please see the signal flow graph of the different length split-radix-2/4 FFT algorithm as shown in FIG. 3 and FIG. 12. FIG. 3 is a preferred signal flow graph of the present invention showing the butterfly operation algorithm, and FIG. 12 is a preferred embodiment of the present invention showing the state of the digital signal processing structure. As can be seen from these figures, the twiddle factors all present the same distribution rule in different points of FFT algorithm. It can be seen from the FIG. 12, it is an example of a 64-point split-radix-2/4 FFT state diagram. More, from the L-shape arrangement as shown in the figure, the twiddle factor distribution in the split-radix-2/4 FFT signal flow graph can be defined as two states, which are State 0 and State 1. The twiddle factor in the first stage 121 only presents as the rule of State 0. However, the arrangement of the twiddle factor in the second stage 122 has a distribution rule with 4 groups, which are State 0, State 1, State 0 and State 0. In the third stage 123, the distribution rule of the twiddle factors from top to bottom is State 0, State 1, State 0, State 0, State 0, State 1, State 0, State 1, State 0, State 1, State 0, State 0, State 0, State 1, State 0 and State 0. The distribution rule of the twiddle factor arrangement commonly presents in the signal flow graph of split-radix-2/4 FFT algorithm with different length. The conclusion is given as the following. In the first stage of split-radix-2/4 FFT algorithm, the twiddle factor distribution only presents State 0. The next stage that follows State 0 in the present stage would exhibit 4 corresponding sates which are State 0, State 1, State 0 and State 0 respectively. Otherwise, the next stage that follows State 1 in the present stage would exhibit 4 corresponding sates which are State 0, State 1, State 0 and State 1 respectively. By using the counter value and the state in the previous stage the state in the present stage can be determined. As a result, it can dynamically predict the present required twiddle factor distribution as well as find out the corresponding twiddle factor values by using the look-up table.

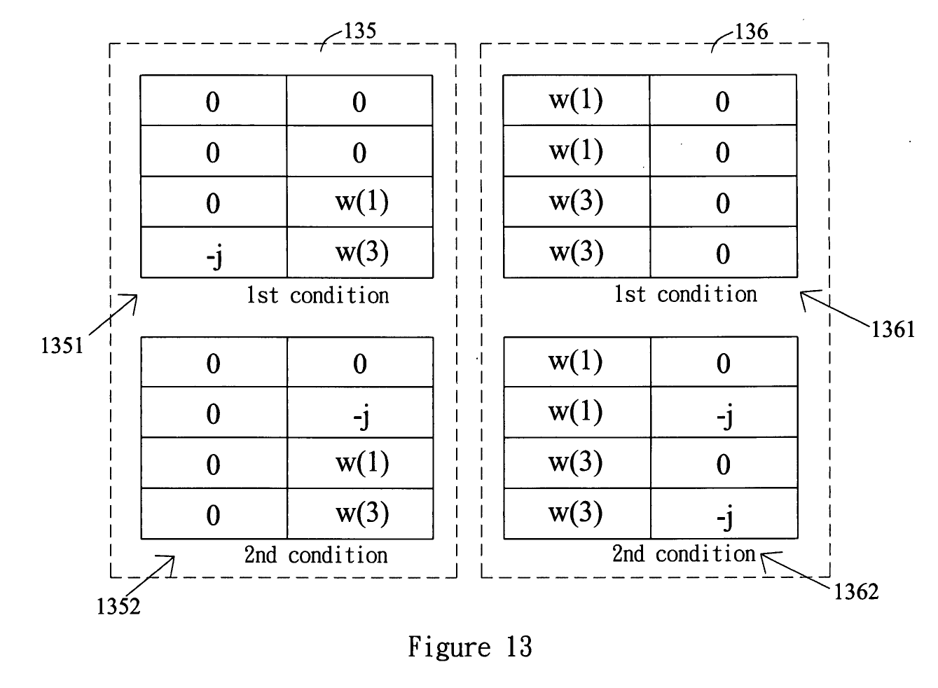

FIG. 13 is a preferred embodiment of the present invention showing the condition of the state of a digital signal processing structure. In this figure, it uses 135 and 136 to represent State 0 and State 1 respectively. The State 0 has two conditions, which are the first condition 1351 of State 0 and the second condition 1352 of State 0. Further, the State 1 has two conditions, which are the first condition 1361 of State 1 and the second condition 1362 of State 1. The 8 blanks in each condition respectively represent 8 possible numbers of the required twiddle factors in two operations of the replicated radix-4 core. The symbol “0” means bypass which is the operation of multiplying 1 for the data. The symbol “−j” means the operation of multiplying −j for the data. The symbol “w” means performing complex twiddle factor multiplication operations. For example, a 64-point split-radix-2/4 FFT algorithm as shown in the FIG. 12 would require 3-stage operation by using the replicated radix-4 core. The replicated radix-4 core of the processor element processes 4 data each time in a stage. It is called a cycle. As a result, each stage requires processing 16 cycles. In the first stage 121, State 0 occupies 16 cycles. In the second stage 122, State 0 and State 1 would occupy 4 cycles respectively. In the final stage 123, State 0 and State 1 occupy 1 cycle respectively.

In the first stage 121, the allocation of the twiddle factors only meets the rule of the State 0. The 4 data in the first cycle are the data in the first memory position 1, the second memory position 5, the third memory position 9, the fourth memory position 13, respectively. The required 8 twiddle factors that performing the two operations in the replicated radix-4 core are 1,1,1,−j and 1,1,W₆₄⁰W₆₄⁰. The 4 data in the second cycle come from the first memory position 13, the second memory position 1, the third memory position 5 and the fourth memory position 9. The twiddle factors that performing the two operations in the replicated radix-4 core are 1,1,1,−j and 1,1,W₆₄¹,W₆₄³. The 4 data in the third cycle are stored in the first memory position 9, the second memory position 13, the third memory position 1 and the fourth memory position 5. The twiddle factors that performing the two operations in the replicated radix-4 core are 1,1,1,−j and 1,1,W₆₄²W₆₄⁶. According to the above method, the previous eight cycles can meet the first condition 1351 of State 0, and the next eight cycles can meet the second condition 1352 of State 0. It can be concluded as the followings. In the present stage, the required twiddle factors of the present cycle are the indexes accumulation from the previous twiddle factors in the previous cycle. More, the accumulation value only has two kinds, which are one and three. Also, each condition can occupy half of the cycles in its state.

Similarly, State 1 presents the similar rule. In summary, the first condition and the second condition individually take half of the cycles in the State 0 and State 1. The prediction from the above states can accurately show the required twiddle factor format and its corresponding values. By using the conventional look-up table which only requires to store approximately ⅛ of the twiddle factors, it can produce all the twiddle factors in all kinds of situations. More, it can find out the required twiddle factor of the said butterfly operation by referring to the above dynamic prediction twiddle factor method.

Achievement of the Invention

A preferred embodiment of this invention has been described in detail hereinabove. The design of an expandable single processor element is applied here. More particularly, the feedback path decreases access times in memories, and the feedback electricity replicates the processor and decreases the numbers of operations. As a result, the purpose of performing preferred embodiments can be achieved by the above description, and the shortages of prior art while applying in hardware can be overcome.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims while which are to be accord with the broadest interpretation so as to encompass all such modifications and similar structures.

What is claimed is:

1. A digital signal processing structure applying a length-scalable fast fourier transformation, comprising:
an address generator, which put the data in a certain address of the memory;
multiple memory banks, which are in the memory and are the places for data storage;
multiple address rotators, which can make address generator generate multiple sets of addresses for circular symmetrical shift;
multiple data rotators, which make data of multiple memory banks do a circular symmetrical shift;
a processor element, which is a processor for performing butterfly operations;
multiple feedback paths, which are the paths for returning data into the processor element;
multiple registers, which are temporary data storage memories for the processor element; and
multiple multiplexers, which can receive the data from multiple feedback paths or from multiple registers, and relocate them; and
multiple demultiplexers, which can receive the operation results from the processor element, and relocate them.

2. The structure said in claim 1, wherein said processor element uses multiple feedback paths to replicate hardware.

3. The structure said in claim 1, wherein said interleave rotated data allocation method can write and read data in multiple memory banks.

4. The structure said in claim 1, wherein said multiple memory banks are multiple single-port memories.

5. The structure said in claim 1, wherein said processor element is a replicated radix-r core.

6. The structure said in claim 1, wherein said address generator is an interleave rotated data allocation address generator with length-scalable feature.

7. The structure said in claim 1, wherein said data of multiple memory banks are stored as a circular symmetrical storage.

8. The structure said in claim 1, wherein said multiple data rotators translate the data to the left or right position.

9. A digital signal processing structure applying a length-scalable Fast Fourier Transformation, and produces a digital structure with an interleave rotated non-conflicting data format comprising:
a plurality of memory storage elements, which are the places for data storage; and
a processor element, which is a processor for performing butterfly operations.

10. The structure said in claim 9, wherein said interleave rotated non-conflicting data format uses multiple data rotators to access multiple data between multiple memory banks and the processor element.

11. The structure said in claim 9, wherein said multiple data rotators translate data to the left or right position.

12. The structure said in claim 9, wherein said multiple storage banks in interleave rotated non-conflicting data format include multiple rows of data storage places.

13. The structure said in claim 9, wherein said the next data storage positions of the multiple rows in interleave rotated non-conflicting data format are one shifted position of the previous row.

14. The structure said in claim 9, wherein said the data storage positions of the multiple rows in the quadruple rows are two shifted position of the previous row.

15. The structure said in claim 9, wherein said processor element is a replicated radix-r core.

16. The structure said in claim 9, wherein said multiple memory banks are multiple single-port memories.

17. The structure said in claim 9, wherein said data of multiple memory banks are stored as a circular symmetrical storage.

18. The structure said in claim 9, wherein said increasing the numbers of processor elements and makes the total efficiency enhanced.

19. The structure said in claim 17, wherein said data of multiple processor elements are divided into odd data and even data separately as arrangement.

20. The structure said in claim 17, wherein said multiple processor elements share the same memory address generator.

21. The structure said in claim 17, wherein said data rotators are accumulated in multiple processor elements and achieve data storage allocation.

22. A digital signal processor structure by performing length-scalable fast fourier transformation herein, and a plurality of twiddle factors of the signal flow graph present the same regularization, which regularization comprising;
a State 0 and
a State 1.

23. The structure said in claim 22, wherein said the order of the next stage in the State 0 including;
State 0,
State 1,
State 0, and
State 0.

24. The structure said in claim 22, wherein said order of the next stage in the State 1 including;
State 0,
State 1,
State 0, and
State 1.

25. The digital signal architecture said in claim 22, wherein said State 0 includes a plurality of conditions.

26. The digital signal architecture said in claim 22, wherein said State 1 includes a plurality of conditions.
